(19) United States
(12) Patent Application Publication
(10) Pub. No.: US 2025/0086656 A1
(43) Pub. Date: Mar. 13, 2025

(54) SYSTEMS AND METHODS FOR PREDICTING AND PREVENTING SOCIAL ENGINEERING SCAMS IN REAL TIME

(71) Applicant: JPMORGAN CHASE BANK, N.A., New York, NY (US)

(72) Inventor: Animesh CHOWDHURY, Fairfax Station, VA (US)

(21) Appl. No.: 18/462,896

(22) Filed: Sep. 7, 2023

(51) Int. Cl. G06Q 30/018; G10L 17/26

(52) U.S. Cl. CPC G06Q 30/0185; G10L 17/26

(57) ABSTRACT

Systems and methods for predicting and preventing social engineering scams in real time are disclosed. According to one embodiment, a method for predicting social engineering scams in real time may include: (1) receiving, at a computer program executed by a user electronic device for a user, a communication; (2) extracting, by the computer program and using a machine learning engine, a pattern from the communication; (3) comparing, by the computer program, the pattern to scam patterns in a local scam database; (4) and generating, by the computer program, an alert in response to the pattern matching one of the scam patterns.

### BACKGROUND OF THE INVENTION

### 1. Field of the Invention

Embodiments relate to systems and methods for predicting and preventing social engineering scams in real time.

### 2. Description of the Related Art

Social engineering scams cost individuals and businesses billions of dollars each year. Social engineering scams are not only used on unsuspecting individuals, but customer support professionals and client managers can be also defrauded by sophisticated social engineering scams. For example, a scammer may impersonate a customer, and may end up receiving the customer's private credentials and device ownerships. The scammer then uses these for fraud.

### SUMMARY OF THE INVENTION

Systems and methods for predicting and preventing social engineering scams in real time are disclosed. According to one embodiment, a method for predicting social engineering scams in real time may include: (1) receiving, at a computer program executed by a user electronic device for a user, a communication; (2) extracting, by the computer program and using a machine learning engine, a pattern from the communication; (3) comparing, by the computer program, the pattern to scam patterns in a local scam database; (4) and generating, by the computer program, an alert in response to the pattern matching one of the scam patterns.

In one embodiment, the communication may include a voice communication or a text communication.

In one embodiment, the method may also include generating, by the computer program, a transcription of the voice communication.

In one embodiment, the pattern may include material content and a sentiment.

In one embodiment, the computer program compares the pattern to the scam patterns using vector distance matching.

In one embodiment, the method may also include determining, by the computer program, a risk score for the user; wherein the computer program generates the alert in response to the pattern matching one of the scam patterns and the risk score being above a threshold.

In one embodiment, the risk score may be based on demographics of the user, a time of year, and a type of transaction involved in the communication.

In one embodiment, the computer program monitors a phone application or a messaging application on the user electronic device.

In one embodiment, the method may also include notifying, by the computer program, a backend of the match, wherein the backend locks an account associated with the user or requires additional authentication from the user.

According to another embodiment, a method for predicting social engineering scams in real time may include: (1) monitoring, by a computer program executed by an agent electronic device for an agent, a voice communication with a user from a user electronic device; (2) extracting, by the computer program, voice elements for the user from the voice communication; (3) retrieving, by the computer program, a voice signature for the user; (4) determining, by the computer program, that the voice elements indicate duress by comparing the voice elements to the voice signature; and (5) generating, by the computer program, an alert in response to the determination.

In one embodiment, the computer program determines the voice elements indicate duress by simulating a voice of the user under duress using the voice signature, and comparing the voice communication to the simulated voice.

In one embodiment, the computer program communicates an alert to the user electronic device.

In one embodiment, the method may also include locking, by the computer program, an account associated with the user.

According to another embodiment, a non-transitory computer readable storage medium may include instructions stored thereon, which when read and executed by one or more computer processors, cause the one or more computer processors to perform steps comprising: receiving a communication from a user of a user electronic device, wherein the communication may include a voice communication or a text communication; extracting, using a machine learning engine, a pattern from the communication; comparing the pattern to scam patterns in a local scam database; and generating an alert in response to the pattern matching one of the scam patterns.

In one embodiment, the non-transitory computer readable storage medium may also include instructions stored thereon, which when read and executed by one or more computer processors, cause the one or more computer processors to generate a transcription of the voice communication.

In one embodiment, the pattern may include material content and a sentiment.

In one embodiment, the pattern may be compared to the scam patterns using vector distance matching.

In one embodiment, the non-transitory computer readable storage medium of claim 14, may also include instructions stored thereon, which when read and executed by one or more computer processors, cause the one or more computer processors to determine a risk score for the user, and the alert may be generated in response to the pattern matching one of the scam patterns and the risk score being above a threshold.

In one embodiment, the risk score may be based on demographics of the user, a time of year, and a type of transaction involved in the communication.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for predicting and preventing social engineering scams in real time according to an embodiment;

FIG. 2 illustrates a method for predicting and preventing social engineering scams in real time according to an embodiment;

FIG. 3 illustrates a method for predicting and preventing social engineering scams in real time according to another embodiment; and

FIG. 4 depicts an exemplary computing system for implementing aspects of the present disclosure.

### DETAILED DESCRIPTION OF PREFERRED EMBODIMENTS

Embodiments relate to systems and methods for predicting and preventing social engineering scams in real time.

Embodiments may detect a social engineering scam in real time using natural language processing machine learning models if an ongoing conversation—voice or text—fits a social engineering scam pattern or signature. Examples of social engineering scam signatures are disclosed in Ali Derakhahsan et al., “Detecting Telephone-Based Social Engineering Attacks Using Scam Signatures,” IWSPA '21: Proceedings of the 2021 ACM Workshop on Security and Privacy Analytics, April 2021, pages 67-73, the disclosure of is hereby incorporated, by reference, in its entirety.

Embodiments may detect a social engineering scam as follows: (1) identify a complete sentence or a collection of sentences from an initiator; (2) de-personalize the sentences by replacing names of people with generic names; and (3) perform a sentiment analysis of the conversation to identify social engineering and the requested action.

If a scam is detected, embodiments may alert the target of the scam—the customer, an agent, etc.—of the scam in real time. Embodiments may use audio, visual, and/or haptic alerts, and may provide mitigation strategies, such as checking the identity of the caller, reminding the target to not be pressured into anything, to validate the context of the call, etc.

In detecting the scam, embodiments may also consider the prior history of the initiator and/or target interaction, the environmental context of the conversation as a feature in the model (e.g., an increased likelihood of a scam in response to a natural disaster), etc. Embodiments may also detect patterns in background noise, detect patterns or tones of speech, such as panic, anxiety, intonation, demeanor, etc. Embodiments may further match the biometric voice signature of a customer with the caller.

Embodiments may create a scam signatures database by extracting information from known social engineering scams, and may enhance scam signatures database by updating new signatures as new scams become known.

Embodiments may create fraud expectations by looking at different signals from an individual's personal profile and external context. For example, seniors and those who are not technologically savvy are often targets of scams. During tax season, there is an expectation of a greater number of IRS-related scams; when a person is going through a life event (e.g., marriage, child birth, divorce, the death of a close relation, moving, etc.), there is an increased expectation of being a target; during natural disasters, holiday seasons, etc., the number of donation-related scams increases; etc. The profile and external events may be used to determine a fraud expectation score, which may assist in detecting a scam.

Embodiments may create a biometric voice signature for users that may be used with generative artificial intelligence to create voice samples for individuals under different stress conditions. Those voice samples may be matched with a user's actual voice data during a conversation to detect a scam.

The voice signatures may include voice signatures for anyone authorized to access the user's account, such as the user's co-account holders, delegates, agents, etc.

Embodiments may create flags in downstream systems, such as banking systems, that cause additional authentication and/or security checks for financial transactions when a scam is detected.

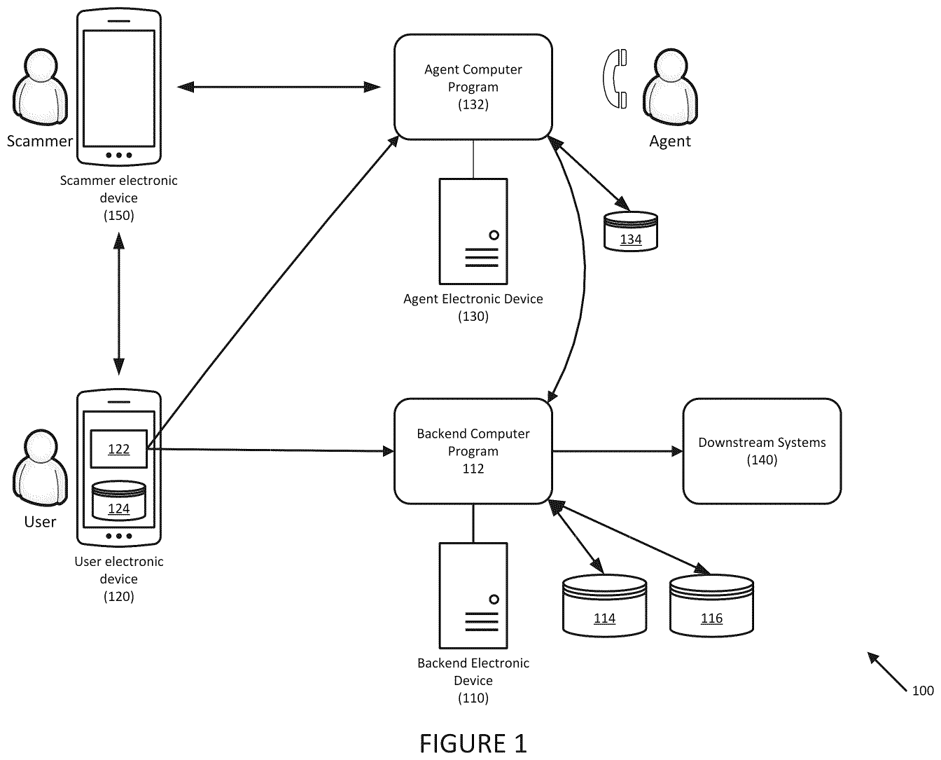

Referring to FIG. 1, a system for predicting and preventing social engineering scams in real time is disclosed according to an embodiment. System 100 may include backend electronic device 110, which may be a server (e.g., physical and/or cloud-based), computer (e.g., workstation, desktop, laptop, tablet, etc.), Internet of Things (IoT) appliance, etc. Backend electronic device 110 may execute backend computer program 112, which may communicate with a plurality of user electronic devices 120, a plurality of agent electronic devices 130, etc. Backend computer program 112 may also communicate with one or more downstream systems 140, such as fraud systems, electronic devices, databases, etc.

Backend computer program 112 may further interact with master scam signature database 134, which may include scam signatures from commercial databases, third parties, etc. In one embodiment, scam signature database may include a machine learning engine that may be trained with historical data to predict scams.

Backend computer program 112 may further maintain voice signature database 116 for one or more users. For example, backend computer program 112 may receive voice data from user electronic device 120 during, for example, registration, communications, etc. and may extract a voice signature from the voice data. Using the voice signatures in voice signature database, backend computer program 112 may then simulate a user's voice under duress and may compare it to the user's voice when the user calls the agent. The audio simulation of how the user would sound under stress may be played back for the agent who is fielding the call from the user. In another embodiment, actual voice may be compared to the audio simulation of the user's voice under duress, and a likelihood of duress may be provided to the agent. In still another embodiment, backend computer program 112 may receive the user's voice and may determine if any differences between it and the voice signature indicate duress.

User electronic device 120 may be any suitable electronic device, including computers (e.g., workstations, desktops, laptops, tablets, etc.), smart devices (e.g., smart phones, smart watches, etc.), IoT appliances, etc. User electronic device 120 may execute user computer program 122, which may monitor and analyze conversations or communications between user electronic device 120 and another electronic device. The conversations or communications may be real-time voice communications, text (e.g., SMS communications), etc. The conversations or communications may also be electronic mail communication, etc.

User electronic device 120 may also maintain local scam signature database 124, which may include at least some of the scam signatures from master scam signature database 124. In one embodiment, the scam signatures included in local scam signature database 124 may be a subset of the scam signatures in master scam signature database 124, and may be relevant to the user of user electronic device 120. For example, if the user does not have a mortgage, the scam signatures for mortgage scams may not be provided to local scam signature database 124.

System 100 may further include agent electronic device 130, which may be any suitable electronic device, including computers (e.g., workstations, desktops, laptops, tablets, etc.), smart devices (e.g., smart phones, smart watches, etc.), IoT appliances, etc. Agent electronic device 130 may execute agent computer program 132, which may monitor and analyze conversations or communications with the agent and a third party. The conversations or communications may be real-time voice communications, text (e.g., SMS communications), etc.

Agent computer program 132 may also maintain local agent scam signature database 134, which may include at least some of the scam signatures from master scam signature database 114. In one embodiment, the scam signatures included in local agent scam signature database 134 may be a subset of the scam signatures in master scam signature database 114, and may be relevant to the agent. For example, if the agent is a credit card agent, the scam signatures for mortgage scams may not be provided to local agent scam signature database 134.

System 100 may also include scammer electronic device 150, which may be any electronic device by which a scammer may communicate with user electronic device 120 and/or agent electronic device 130 by voice text, etc.

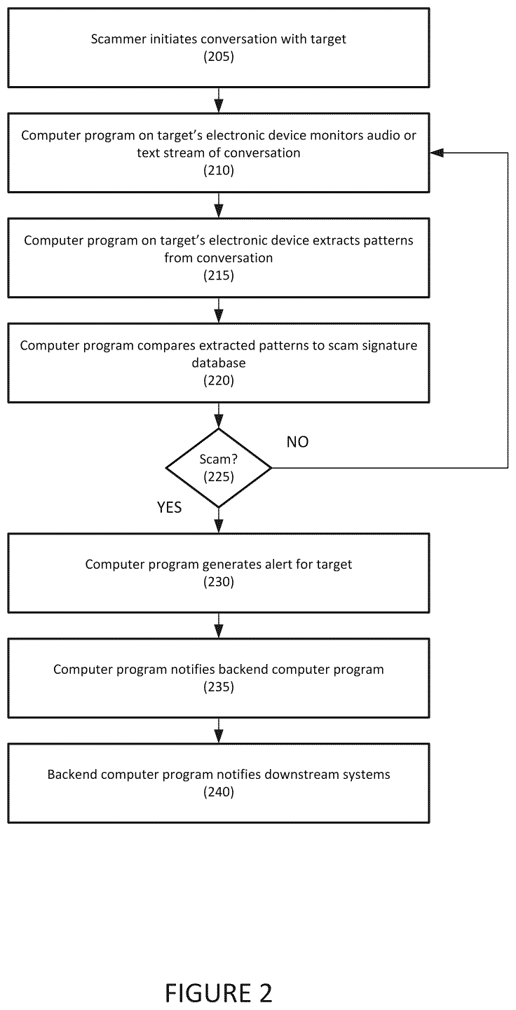

Referring to FIG. 2, a method for predicting and preventing social engineering scams in real time is disclosed according to an embodiment. In step 205, a scammer may initiate a conversation or a communication with a target, such as a customer, an agent, etc. The conversation or communication may be a voice communication, a text communication, etc. For example, the conversation or the communication may be made using a phone application, a messaging application, etc.

In step 210, a computer program on the target's electronic device may monitor the audio or a text stream of the conversation. For example, the computer program may monitor an application, such as a messaging application, a phone application, etc. In one embodiment, the voice conversation may be transcribed into text.

In step 215, the computer program on the target's electronic device may extract patterns from the conversation. For example, the computer program may review groups of words, entire sentences, etc. using a trained machine learning engine to identify the material content and the sentiment of the word group or sentence. The content and the sentiment may then be provided to another model in order to identify any matches for the content and sentiment with known scam signatures.

In step 220, the computer program on the target's electronic device may compare the extracted content and the sentiment to patterns in a local scam signature database. In one embodiment, the extracted content and the sentiment may be matched using a matching method, such as vector distance matching. For example, groups of words from the conversation (e.g., the raw transcribed text of the conversation) may be provided as an input to a Natural Language Processing machine learning model that vectorizes the word group and then matches the similarity of the input word vector to the vectors created from the known scam signatures. The closer the two vectors are, the higher is the score that the input sentence from the conversation is indicative of spam.

In one embodiment, the computer program on the target's electronic device may score the match, and may also determine a risk factor for the scam. For example, the risk factor may be based on the demographics of the user (e.g., young, old, education level, etc.), time of year (e.g., holiday season, tax season, etc.), environmental events (e.g., disasters, severe weather, etc.).

Other factors contributing to the risk score may include the type of the account (e.g., personal, business, etc.), the types of transactions that is typical for the account (e.g., domestic retail transactions, international transactions, business-to-business transactions, investment transactions, etc.), the net worth of the individual, etc.

The risk factor may be used to determine the level of risk for the user. For example, if the user is deemed to have a “high risk of hack,” this may add to the combined risk score for a given conversation. When the combined risk score reaches a pre-determined threshold, a “spam” risk flag and a corresponding alert—e.g., visual, textual, haptic, etc.—may be generated and delivered to the user, the user's caregivers/delegates, the and/or the customer's agent, etc.

In step 225, if a pattern matches, in step 230, the computer program on the target's electronic device may generate an alert for the target electronic device. For example, the alert may be an in-app message for the application over which the conversation is taking place, it may be a push notification, it may be a text message, it may be an email, device feedback (e.g., haptic vibration, noises, etc.), etc.

In one embodiment, the computer program may notify a caregiver, a custodian, a trustee or a joint account holder, a supervisor, etc. of a risk identification.

In step 235, the computer program on the target's electronic device may notify a backend computer program of the match, and in step 240, the backend computer program may notify downstream systems of the match. The downstream systems may take any appropriate action, such as locking one or more accounts associated with the user, requiring heightened authentication, etc.

If there is not a scam, the computer program on the target's electronic device may continue with monitoring the conversation.

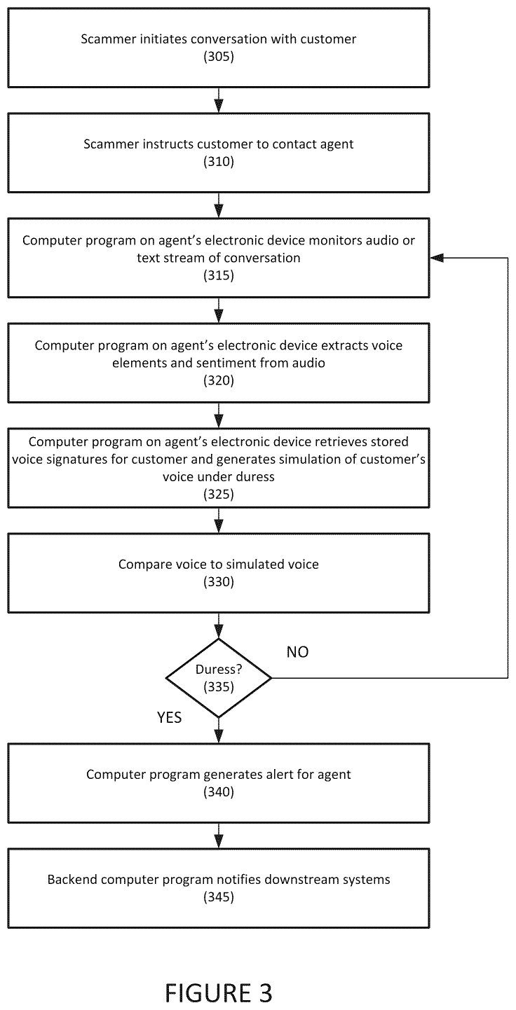

Referring to FIG. 3, a method for predicting and preventing social engineering scams in real time is disclosed according to an embodiment. In step 305, a scammer may initiate a conversation or a communication with a customer or an authorized individual (e.g., co-account holder, agent, delegate, etc.). The conversation or communication may be a voice communication, a text communication, etc. For example, the conversation or the communication may be made using a phone application, a messaging application, etc.

In step 310, the scammer may instruct the customer or authorized individual to contact an entity with which the customer may have an account, such as a financial institution. The customer may contact the entity using voice, such as via a phone call.

In step 315, a computer program on an electronic device for the agent of the entity may monitor the audio stream of the conversation with the customer.

In step 320, the computer program on the agent's electronic device may extract voice elements and a sentiment from the audio from the customer or authorized individual. In one embodiment, the computer program reviews groups of words, entire sentences, etc. using a trained machine learning engine to identify the material content and the sentiment of the word group or sentence.

In step 325, the computer program on the agent's electronic device may retrieve stored voice signatures for the customer or the authorized individual may generate a simulation of the customer's or the authorized individual's voice under duress. For example, a generative artificial intelligence model may be used to create customer speech. The model may be seeded with the voice signature of a customer. The simulated voice may be the voice audio of a customer speaking the same phrase that is coming from the person who is posing as a customer, but with a simulation of the impact of stress on the voice.

Examples of the use of voice biometrics are disclosed in K., Amjad & Aithal, Sreeramana. “Voice Biometric Systems for User Identification and Authentication—A Literature Review” International Journal of Applied Engineering and Management Letters. 198-209. 10.47992/IJAEML.2581.7000.0131 (2022), the disclosure of which is hereby incorporated, by reference, in its entirety.

In step 330, the computer program on the agent's electronic device may compare the actual voice to the simulated voice in order to assess a difference. In another embodiment, the computer program on the agent's electronic device may play the simulated voice under duress for the agent, and the agent may assess whether the customer is under duress. In still another embodiment, the computer program on the agent's electronic device may assess the voice to determine if there is stress without generating the simulation.

In one embodiment, the computer program on the target's electronic device may score the match, and may also determine a risk factor for the scam. For example, the risk factor may be based on the demographics of the user (e.g., young, old, education level, etc.), time of year (e.g., holiday season, tax season, etc.), environmental events (e.g., disasters, severe weather, etc.).

Other factors contributing to the risk score may include the type of the account (e.g., personal, business, etc.), the types of transactions that is typical for the account (e.g., domestic retail transactions, international transactions, business-to-business transactions, investment transactions, etc.), the net worth of the individual, etc.

The risk factor may be used to determine the level of risk for the user.

In step 335, if duress is detected, in step 340, the computer program may generate an alert, such as in-app message, a pop-up message, etc. for the agent. The computer program may also generate an alert for the customer that may be sent to the customer's electronic device, such as an in-app message, a push notification, a text message, it may be an email, etc. The computer program may also notify a caregiver, a custodian, a trustee or a joint account holder, a supervisor, etc. of a risk identification.

In step 345, the computer program on the agent's electronic device may notify downstream systems of the match. The downstream systems may take any appropriate action, such as locking one or more account associated with the user, requiring heightened authentication, etc.

In one embodiment, if duress is detected, the process may continue with the process of FIG. 2, such as performing pattern matching.

If there is no duress, the computer program on the target's electronic device may continue with monitoring the conversation.

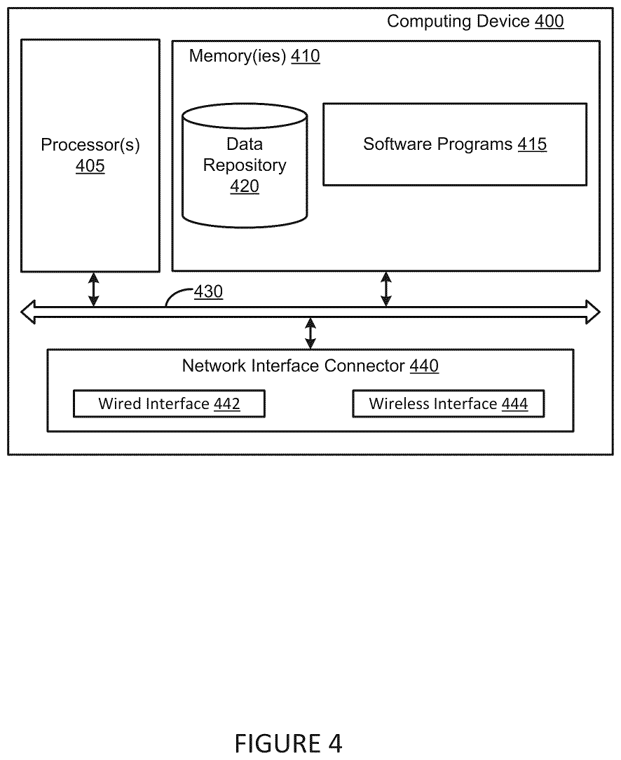

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for predicting social engineering scams in real time, comprising:
receiving, at a computer program executed by a user electronic device for a user, a communication;
extracting, by the computer program and using a machine learning engine, a pattern from the communication;
comparing, by the computer program, the pattern to scam patterns in a local scam database; and
generating, by the computer program, an alert in response to the pattern matching one of the scam patterns.

2. The method of claim 1, wherein the communication comprises a voice communication or a text communication.

3. The method of claim 2, further comprising:
generating, by the computer program, a transcription of the voice communication.

4. The method of claim 1, wherein the pattern comprises material content and a sentiment.

5. The method of claim 1, wherein the computer program compares the pattern to the scam patterns using vector distance matching.

6. The method of claim 1, further comprising:
determining, by the computer program, a risk score for the user;
wherein the computer program generates the alert in response to the pattern matching one of the scam patterns and the risk score being above a threshold.

7. The method of claim 6, wherein the risk score is based on demographics of the user, a time of year, and a type of transaction involved in the communication.

8. The method of claim 1, wherein the computer program monitors a phone application or a messaging application on the user electronic device.

9. The method of claim 1, further comprising:
notifying, by the computer program, a backend of the match, wherein the backend locks an account associated with the user or requires additional authentication from the user.

10. A method for predicting social engineering scams in real time, comprising:
monitoring, by a computer program executed by an agent electronic device for an agent, a voice communication with a user from a user electronic device;
extracting, by the computer program, voice elements for the user from the voice communication;
retrieving, by the computer program, a voice signature for the user;
determining, by the computer program, that the voice elements indicate duress by comparing the voice elements to the voice signature; and
generating, by the computer program, an alert in response to the determination.

11. The method of claim 10, wherein the computer program determines the voice elements indicate duress by simulating a voice of the user under duress using the voice signature, and comparing the voice communication to the simulated voice.

12. The method of claim 10, wherein the computer program communicates an alert to the user electronic device.

13. The method of claim 10, further comprising:
locking, by the computer program, an account associated with the user.

14. A non-transitory computer readable storage medium, including instructions stored thereon, which when read and executed by one or more computer processors, cause the one or more computer processors to perform steps comprising:
receiving a communication from a user of a user electronic device, wherein the communication comprises a voice communication or a text communication;
extracting, using a machine learning engine, a pattern from the communication;
comparing the pattern to scam patterns in a local scam database; and
generating an alert in response to the pattern matching one of the scam patterns.

15. The non-transitory computer readable storage medium of claim 14, further comprising instructions stored thereon, which when read and executed by one or more computer processors, cause the one or more computer processors to generate a transcription of the voice communication.

16. The non-transitory computer readable storage medium of claim 14, wherein the pattern comprises material content and a sentiment.

17. The non-transitory computer readable storage medium of claim 14, wherein the pattern is compared to the scam patterns using vector distance matching.

18. The non-transitory computer readable storage medium of claim 14, further comprising instructions stored thereon, which when read and executed by one or more computer processors, cause the one or more computer processors to determine a risk score for the user, and the alert is generated in response to the pattern matching one of the scam patterns and the risk score being above a threshold.

19. The non-transitory computer readable storage medium of claim 18, wherein the risk score is based on demographics of the user, a time of year, and a type of transaction involved in the communication.
